(19) United States
(12) Patent Application Publication
(10) Pub. No.: US 2018/0339317 A1
(43) Pub. Date: Nov. 29, 2018

(54) CYCLONE TEMPERATURE CONTROL FOR DECOATING SYSTEMS

(71) Applicant: Novelis Inc., Atlanta, GA (US)

(72) Inventors: JungYoung Son, Ulsan (KR); Edwin L. Rauch, Fulton, NY (US); Augusto Cesar Silva, Roswell, GA (US)

(73) Assignee: Novelis Inc., Atlanta, GA (US)

(21) Appl. No.: 15/990,007

(22) Filed: May 25, 2018

Related U.S. Application Data
(60) Provisional application No. 62/511,382, filed on May 26, 2017.

(51) Int. Cl. B08B 7/00; F23G 7/06; F23G 5/50

(52) U.S. Cl. CPC B08B 7/0085; F23G 7/065; F23G 5/50; B08B 2220/04; F23G 2204/103; F23G 2207/101; F23G 2203/30

(57) ABSTRACT

A cyclone temperature control system for a cyclone of a decoating system includes a controller, a gas mover, and a control valve that is movable between a fully open position and a closed position. A method of controlling the temperature of the cyclone includes determining a cyclone temperature of the cyclone and comparing the cyclone temperature to a cyclone threshold temperature. The method also includes opening the temperature control valve and directing at least some heated gas from an afterburner of the decoating system to mix with exhaust gas from a kiln of the decoating system to increase the temperature of the exhaust gas if the cyclone temperature is less than the cyclone threshold temperature.

### REFERENCE TO RELATED APPLICATIONS

This application claims the benefit of U.S. Provisional Application No. 62/511,382, filed on May 26, 2017 and entitled CYCLONE TEMPERATURE CONTROL FOR DECOATING SYSTEMS, the disclosure of which are hereby incorporated by reference in its entirety.

### FIELD OF THE INVENTION

This application relates to metal recycling, and more particularly to decoating systems for metal recycling.

### BACKGROUND

During metal recycling, metal scrap (such as aluminum or aluminum alloys) are crushed, shredded, chopped, or otherwise reduced into smaller pieces of metal scrap. Oftentimes, the metal scrap has various coatings, such as oils, paints, lacquers, plastics, inks, and glues, as well as various other organic contaminants such as paper, plastic bags, polyethylene terephthalate (PET), sugar residues, etc., that must be removed through a decoating process before the metal scrap can be further processed and recovered.

During decoating with a decoating system, the organic compounds are thermally cracked and some of the organic compounds are condensed and removed as dust, along with other finely divided materials (aluminum fines, clay, glass, various inorganic materials such as pigments, etc.), through a dust cyclone of the decoating system. Because this dust contains high concentration of organic compounds and other combustibles such as metallic powder, the dust is susceptible to spontaneous combustion and the creation of dust fires when it is discharged from the decoating system. These fires are very difficult to extinguish, even with water or fire extinguishers. Moreover, if water were used to wet the dust to make a slurry mixture of the water and dust, the mixture may be costly to dispose of due to the content of the slurry mixture, the process may be costly to implement because of the quantity of water needed on a daily basis, and the mixture may present potential safety and environmental issues.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

In various examples, a decoating system includes a dust cyclone, an afterburner, and a cyclone temperature control system. The dust cyclone has a cyclone temperature that must be maintained within a controllable range and is configured to receive an exhaust gas having an indirectly controlled exhaust gas temperature from a decoating kiln and to filter particulate matter from the exhaust gas as dust. The afterburner is configured to produce a heated gas at a directly controlled heated gas temperature. The heated gas temperature is greater than the kiln exhaust gas temperature. The cyclone temperature control system is configured to selectively mix at least some of the afterburner heated gas with the exhaust gas from the decoating kiln such that the cyclone temperature is at least at a minimum threshold cyclone temperature during operation, which corresponds to a minimum temperature of dust discharged from the cyclone. In some examples, dust discharged from the dust cyclone does not combust or has a reduced tendency to combust when exposed to ambient air compared to traditional decoating systems.

In some examples, the cyclone temperature control system includes a controller, a gas mover, and a control valve that is movable between a fully open position and a closed position. In various examples, a method of controlling a temperature of a dust cyclone of a decoating system includes determining a temperature of exhaust gas from a kiln of the decoating system before the exhaust gas enters the dust cyclone of the decoating system and comparing the temperature of the exhaust gas to a cyclone threshold temperature. The method also includes opening the temperature control valve, turning on the gas mover, and directing at least some heated gas from an afterburner of the decoating system to mix with the exhaust gas from the kiln and increase the temperature of the exhaust gas if the temperature of the exhaust gas is less than the cyclone threshold temperature.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic diagram depicting a decoating system according to aspects of the present disclosure.

FIG. 2 is a flowchart depicting a cyclone temperature control process for the decoating system of FIG. 1.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

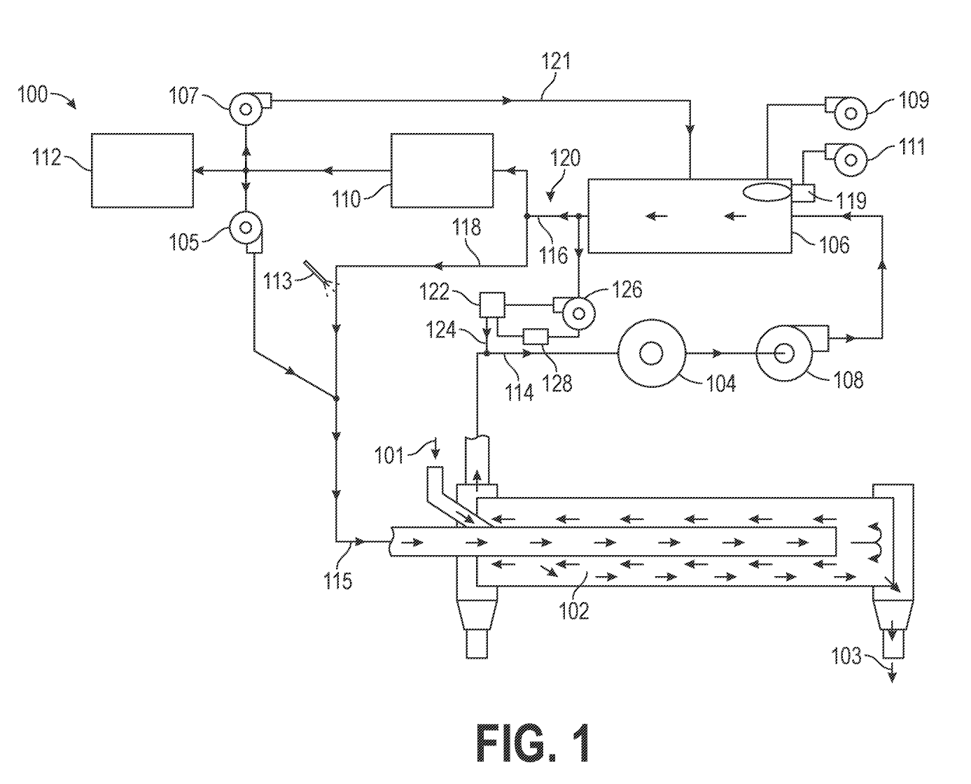

FIG. 1 illustrates a decoating system 100 for removing coatings from metal scrap, such as aluminum or aluminum alloys, according to aspects of the present disclosure. The decoating system 100 includes a kiln 102, a cyclone 104 (or other suitable solid/gas separator), and an afterburner 106. The disclosure of the kiln 102 should not be considered limiting on the current disclosure. While the kiln 102 is illustrated with an internal tube for gas entry and both the gas entry and exit are on the same side of the kiln, it will be appreciated various other types of kilns may be provided. For example, in other cases, a kiln may be provided that omits the internal tube, and the gas entry and gas exit are on opposite sides of the kiln. Various other configurations may be utilized. Other components such as a recirculation fan 108, a heat exchanger 110, and an exhaust system 112 may also optionally be included as part of the decoating system 100. As described in detail below, the decoating system 100 includes a cyclone control system 120 to control a temperature inside the cyclone 104.

During a decoating process with the decoating system 100, metal scrap 101 is fed into the kiln 102. Heated gas 115 is injected into the kiln 102 to raise the temperature within the kiln 102 and vaporize and thermally crack the organic coatings without melting the metal scrap. In many cases, the oxygen concentration within the decoating system 100 is maintained at a low level (such as from about 6% to about 8% oxygen) such that the organic compounds do not ignite. For example, within the decoating system, the atmosphere may be 7% oxygen such that the organic compounds do not ignite even though they are at elevated temperatures due to the decoating process. Decoated scrap metal 103 is removed from the kiln 102 for further processing and ultimately processing into new aluminum products. As the scrap progress through the kiln 102, it is heated by the gases, thereby cooling said gases. This thermal profile causes certain organic compounds that had previously vaporized to re-condense onto the surface of particulate matter.

Exhaust gas containing the vaporized organic compounds and particulate matter exits the kiln 102 through a duct 114, which connects the kiln 102 to the cyclone 104. Within the cyclone 104, larger particulates containing condensed organic compound particulates are removed from the exhaust gas as dust, along with other finely divided materials (aluminum fines, clay, glass, various inorganic materials such as pigments, etc.), and ultimately discharged from the cyclone 104 for disposal. From the cyclone 104, the exhaust gas is directed into the afterburner 106. The afterburner 106 incinerates the remaining organic compounds within the exhaust gas, and discharges a heated gas into a duct 116 that ultimately leads to the exhaust system 112 (e.g., a baghouse) or the atmosphere. The temperature of the heated gas within the duct 116 is greater than the temperature of the exhaust gas from the kiln 102 within the duct 114. For example, in various cases, the temperature of the exhaust gas within the duct 114 is generally from about 250° C. to about 400° C., while the temperature of the heated gas within the duct 116 is generally from about 700° C. to about 900° C. Some of the heated gas exiting the afterburner 106 is optionally recirculated back to the kiln 102 through a recirculation duct 118. In various examples, cooling devices 113 (such as water sprayers) are provided to cool a temperature of the heated gas from the afterburner 106 before the gas is recirculated back to the kiln 102.

As illustrated in FIG. 1, in some examples, the exhaust gas exiting the afterburner 106 through the duct 116 is directed through the heat exchanger 110 that reduces a temperature of the exhaust gas. In various examples, some of the cooled exhaust gas exiting the heat exchanger 110 may be recirculated through a gas mover 105 back to the kiln 102. Alternatively or additionally, some of the cooled exhaust gas exiting the heat exchanger 110 may be recirculated through a gas mover 107 back to the afterburner 106 to prevent overheating when excessive organic compounds are being processed, while still controlling the atmosphere within the afterburner 106. In various examples, additional gas movers 109 and 111 are provided to supply oxygen to combust the organic compounds and control the atmosphere within the afterburner 106 (gas mover 109) and burner combustion (gas mover 111).

As illustrated in FIG. 1, to control a temperature of the cyclone 104, the decoating system 100 includes a cyclone control system 120. The cyclone control system 120 includes a temperature control valve 122, a temperature control duct 124 that connects the duct 116 with the duct 114, and a gas mover 126. A controller 128 is in communication with the temperature control valve 122 and the gas mover 126, as well as one or more temperature sensors (not shown) at an inlet of the cyclone 104, at a position along the duct 114 between the junction with the temperature control duct 124 and the cyclone 104, or other suitable location for detecting the temperature of the cyclone 104. As described in detail below, the controller 128 is configured to control the cyclone temperature such that the cyclone temperature is at or above a threshold cyclone temperature.

The gas mover 126 is a fan or other similar mechanism that forcefully moves or directs fluid flow. The gas mover 126 is configured to operate at high operating temperatures because the heated gas exits the afterburner 106 at elevated temperatures. For example, the gas mover 126 may be configured to operate at temperatures up to about 800° C., temperatures up to about 1000° C., or various other temperatures such that the gas mover can accommodate the heated gas from the afterburner 106.

The temperature control valve 122 is movable to various positions between a fully open position and a closed position. In the open position or a partially opened position, a flow path is defined from the duct 116 through the gas mover 126 to the duct 114 through the temperature control valve 122 and the temperature control duct 124. In the open position, the gas mover 126 forcefully directs at least some of the heated gas from the afterburner 106 to follow the flow path through the temperature control duct 124 and ultimately mix with the exhaust gas from the kiln 102 in the duct 114. In the closed position, the temperature control valve 122 prevents the heated gas from the afterburner 106 from flowing through the temperature control duct 124. In the closed position, the gas mover 126 is optionally turned off.

The amount of heated gas flowing through the temperature control duct 124 is dependent on the position of the temperature control valve 122. For example, in the fully open position, a maximum amount of heated gas may flow through the temperature control duct 124, On the other hand, in a partially open position (e.g. halfway between the closed position and fully open position), a reduced amount of heated gas may flow through the temperature control duct 124.

In the absence of the cyclone control system 120, there is generally no ability to independently control a temperature of the cyclone 104, and the cyclone temperature is generally dependent on the temperature of the exhaust gas as it exits the kiln 102 into the duct 114. More specifically, there is no ability to independently increase the cyclone temperature relative to the temperature of the exhaust gas as it exits the kiln 102. While the temperature of the kiln 102 may be elevated in some cases to produce an exhaust gas having an increased temperature (and therefore an increased cyclone temperature), operating the kiln 102 at elevated temperatures over a prolonged period of time increases the risk of thermitting (burning of metal within the kiln 102) and other damage to the kiln 102.

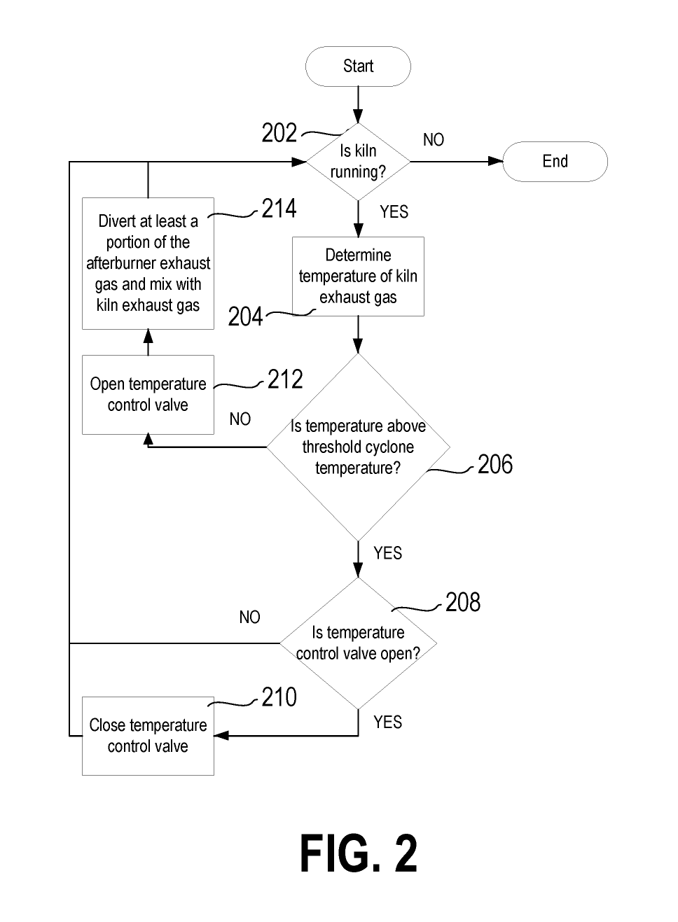

FIG. 2 is a flowchart showing an example of a method for controlling the temperature of the cyclone 104 with the cyclone control system 120. Referring to FIG. 2, the cyclone control system 120 controls the temperature of the cyclone while the kiln 102 is operating. If the kiln 102 is operating in a step 202, in a step 204, the controller 128 detects and determines the cyclone temperature through the one or more sensors such as at an inlet of the cyclone 104 or at a position along the duct 114 between the junction with the temperature control duct 124 and the cyclone 104, among other locations. After detecting the cyclone temperature, the controller 128 determines if the detected temperature is at or above the threshold cyclone temperature.

Traditionally, the cyclone temperature is a temperature that correlates with dust having a dust temperature that is susceptible to combustion when the dust is discharged from the decoating system 100 and exposed to ambient air. For example, when the condensed organic compounds are discharged as dust out of the cyclone into the presence of ambient air (with about 21% oxygen), the temperature of the dust leads to burning of the dust. These dust fires are very difficult to extinguish, even with water or fire extinguishers. Moreover, if water were used to wet the dust to make a slurry mixture of the water and dust, the mixture may be costly to dispose of due to the content of the slurry mixture, the process may be costly to implement because of the quantity of water needed on a daily basis, and the mixture may present potential safety and environmental issues.

To address these problems, it was thought that lower cyclone temperatures would be better for cyclone dust processing to reduce the risk of fire, but after experimentation, it was found that lower cyclone temperatures resulted in dust fires. It was further surprisingly found that, counterintuitive to the traditional thinking, a key to reducing dust fires was to increase the cyclone temperature to remove more organic compounds from the dust. By controlling the cyclone temperature to be at or above the threshold cyclone temperature, sufficient organic compounds are flashed off from the dust and a temperature of the cyclone dust discharged from the cyclone 104 is at a dust temperature that thus reduces or prevents combustion of the cyclone dust when exposed to ambient air.

In various examples, the threshold cyclone temperature is a temperature from greater than about 330° C. to about 550° C., such as a temperature from about 340° C. to about 415° C., such as a temperature from about 350° C. to about 385° C., such as a temperature of about 370° C. In various examples, these threshold cyclone temperatures correspond with dust temperatures of from about 240° C. to about 500° C., such as from about 250° C. to about 310° C., such as about 300° C.

If the controller 128 determines that the cyclone temperature is less than the threshold cyclone temperature, in a step 212, the controller 128 communicates with the temperature control valve 122 and moves the temperature control valve 122 such that it is not in the closed position. In some examples, the extent to which the temperature control valve 122 is opened (e.g., to a partially open position or the fully open position) may depend on the difference between the detected temperature and the threshold cyclone temperature, the desired rate of temperature increase within the cyclone, or various other factors determined by the controller 128 and/or input by a user of the cyclone control system 120. In a step 214, the controller 128 communicates with the gas mover 126 such that the gas mover 126 is operating and accordingly diverts at least some of the heated gas from the afterburner 106 from the duct 116 and into the temperature control duct 124. While steps 212 and 214 are illustrated sequentially, in various examples, the operations in steps 212 and 214 may occur simultaneously or in the reverse order. By opening the temperature control valve 122 and directing the afterburner heated gas from the duct 116 through the temperature control duct 124 by the gas mover 126, the afterburner heated gas mixes with the exhaust gas from the kiln 102 and increases the temperature of the exhaust gas before it enters the cyclone 104, thereby increasing the cyclone temperature. After the temperature control valve 122 is opened from the closed position and the gas mover 126 directs at least some of the afterburner heated gas from the duct 116 through the temperature control duct 124 to the duct 114, the operation returns to step 202.

If the controller 128 determines in step 206 that the cyclone temperature is above the threshold cyclone temperature, in a step 208, the controller 128 determines if the temperature control valve 122 is not in the closed position (e.g., a partially open position or the fully open position). If the temperature control valve 122 is in the closed position, the operation returns to step 202. If the temperature control valve 122 is not in the closed position, in a step 210, the controller 128 communicates with the temperature control valve 122 to position the temperature control valve 122 in the closed position before returning to step 202. In some cases, the controller 128 optionally further communicates with the gas mover 126 to turn the gas mover 126 off when the temperature control valve 122 is in the closed position. In various examples, the operation continues until the controller 128 determines that the kiln 102 is no longer running in step 202.

In various other examples, gas flow through the temperature control duct 124 is controlled by adjusting a speed or rate at which the gas mover 126 directs gas into the temperature control duct 124. In such cases, the controller 128 may be configured to open and close the control valve 122 to either allow afterburner heated gas flow (e.g., during normal operating conditions) or prevent gas flow (e.g., during abnormal operating conditions or an emergency). In these examples, the gas mover 126 may include an inverter or other suitable mechanism for varying the speed or rate at which the gas mover 126 directs gas into the temperature control duct 124.

A method of controlling gas flow through the temperature control duct 124 with the gas mover 126 includes determining whether a temperature of the kiln exhaust gas is above the threshold cyclone temperature. If the temperature of the kiln exhaust gas is not above the threshold cyclone temperature, the speed of the gas mover 126 is gradually increased to direct more hot afterburner exhaust gas toward the cyclone 104. If the temperature of the kiln exhaust gas is above the threshold cyclone temperature, the speed of the gas mover 126 is gradually decreased to reduce the amount of hot afterburner exhaust gas directed toward the cyclone 104. In some examples, during startup operations of the decoating system 100, the control valve 122 may be closed and the gas mover 126 is running at a minimum speed. In such examples, the control valve 122 may remain closed until the kiln exhaust gas temperature reaches a predetermined temperature. During an emergency or abnormal situation, the control valve 122 may be closed while the gas mover 126 reduces its speed.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A decoating system comprising: a dust cyclone having a cyclone temperature and configured to: receive an exhaust gas from a decoating kiln; and filter particulate matter from the exhaust gas as dust; an afterburner configured to produce a heated gas at a heated gas temperature, wherein the heated gas temperature is greater than the cyclone temperature; and a cyclone temperature control system configured to selectively mix at least some of the afterburner heated gas with the exhaust gas from the decoating kiln such that the cyclone temperature is at least at a cyclone threshold temperature during operation.

EC 2. The decoating system of any of the preceding or subsequent example combinations, further comprising the decoating kiln, wherein the decoating kiln comprises: a heating chamber; a gas inlet for receiving an entry gas into the heating chamber; a gas outlet for exhausting the exhaust gas from the heating chamber; a scrap metal inlet for receiving scrap metal into the heating chamber; and a scrap metal outlet for discharging the scrap metal from the heating chamber.

EC 3. The decoating system of any of the preceding or subsequent example combinations, wherein at least some of the entry gas comprises at least some of the heated gas from the afterburner.

EC 4. The decoating system of any of the preceding or subsequent example combinations, wherein the afterburner is configured to generate the heated gas by heating the exhaust gas from the dust cyclone.

EC 5. The decoating system of any of the preceding or subsequent example combinations, wherein the cyclone temperature control system is configured to selectively mix at least some of the heated gas with the exhaust gas before the exhaust gas enters the dust cyclone.

EC 6. The decoating system of any of the preceding or subsequent example combinations, wherein the cyclone threshold temperature corresponds to a temperature of the dust discharged from the dust cyclone at which the dust does not combust when exposed to ambient air.

EC 7. The decoating system of any of the preceding or subsequent example combinations, wherein the cyclone threshold temperature is from about 330° C. to about 550° C.

EC 8. The decoating system of any of the preceding or subsequent example combinations, wherein the cyclone threshold temperature is from about 340° C. to about 415° C.

EC 9. The decoating system of any of the preceding or subsequent example combinations, wherein the cyclone threshold temperature is from about 350° C. to about 385° C.

EC 10. The decoating system of any of the preceding or subsequent example combinations, wherein the cyclone threshold temperature is about 370° C.

EC 11. The decoating system of any of the preceding or subsequent example combinations, wherein the cyclone temperature control system comprises: a controller; a gas mover configured to direct the heated gas to flow from the afterburner to mix with the exhaust gas; and a control valve movable between a fully open position and a fully closed position.

EC 12. The decoating system of any of the preceding or subsequent example combinations, wherein the controller is configured to: determine the cyclone temperature; compare the cyclone temperature to the cyclone threshold temperature; position the control valve in at least a partially open position and turn on the gas mover if the cyclone temperature is below the cyclone threshold temperature to direct the heated gas from the afterburner to mix with the exhaust gas; and position the control valve in a closed position and turn off the gas mover if the cyclone temperature is at or above the cyclone threshold temperature, wherein in the closed position, the control valve prevents the flow of the heated gas from the afterburner to mix with the exhaust gas.

EC 13. The decoating system of any of the preceding or subsequent example combinations, wherein the gas mover is a high temperature service fan.

EC 14. The decoating system of any of the preceding or subsequent example combinations, wherein the high temperature service fan is configured to operate at a temperature of at least about 800° C.

EC 15. The decoating system of any of the preceding or subsequent example combinations, wherein the high temperature service fan is configured to operate at a temperature of up to about 1000° C.

EC 16. A method of controlling a temperature of a dust cyclone of a decoating system comprising: determining a cyclone temperature of the dust cyclone of the decoating system; comparing the cyclone temperature to a cyclone threshold temperature; and opening a temperature control valve, turning on a gas mover, and directing at least some heated gas from an afterburner of the decoating system to mix with exhaust gas from a kiln of the decoating system to increase the temperature of the exhaust gas before it enters the dust cyclone if the cyclone temperature is less than the cyclone threshold temperature.

EC 17. The method of any of the preceding or subsequent example combinations, wherein opening the temperature control valve comprises positioning the temperature control valve in a partially open position such that less than a maximum amount of heated gas is directed to mix with the exhaust gas.

EC 18. The method of any of the preceding or subsequent example combinations, wherein opening the temperature control valve comprises positioning the temperature control valve in a fully open position such that a maximum amount of heated gas is directed to mix with the exhaust gas.

EC 19. The method of any of the preceding or subsequent example combinations, further comprising: closing the temperature control valve and turning off the gas mover to prevent the heated gas from mixing with the exhaust gas from the kiln if the cyclone temperature is above the cyclone threshold temperature.

EC 20. The method of any of the preceding or subsequent example combinations, wherein the cyclone threshold temperature is from about 330° C. to about 450° C.

EC 21. The method of any of the preceding or subsequent example combinations, wherein the cyclone threshold temperature is from about 340° C. to about 415° C.

EC 22. The method of any of the preceding or subsequent example combinations, wherein the cyclone threshold temperature is from about 350° C. to about 385° C.

EC 23. The method of any of the preceding or subsequent example combinations, wherein the cyclone threshold temperature is about 370° C.

EC 24. A cyclone temperature control system for a dust cyclone of a decoating system comprising: a controller; a gas mover; and a control valve movable between a fully open position and a fully closed position, wherein the controller is configured to: determine a cyclone temperature of the dust cyclone; compare the cyclone temperature to a cyclone threshold temperature; and position the control valve in at least a partially open position and turn on the gas mover if the cyclone temperature is below the cyclone threshold temperature to direct heated gas from an afterburner of the decoating system to mix with exhaust gas from a kiln of the decoating system.

EC 25. The cyclone temperature control system of any of the preceding or subsequent example combinations, wherein the controller is further configured to position the control valve in a closed position and turn off the gas mover if the cyclone temperature is at or above the cyclone threshold temperature, wherein in the closed position, the control valve prevents flow of the heated gas from the afterburner to mix with the exhaust gas.

EC 26. The cyclone temperature control system of any of the preceding or subsequent example combinations, wherein the controller is configured to position the control valve in the fully open position if the cyclone temperature is less than the cyclone threshold temperature such that a maximum amount of heated gas is directed to mix with the exhaust gas.

EC 27. The cyclone temperature control system of any of the preceding or subsequent example combinations, wherein the gas mover is a high temperature service fan.

EC 28. The cyclone temperature control system of any of the preceding or subsequent example combinations, wherein the high temperature service fan is configured to operate at a temperature of at least about 800° C.

EC 29. The cyclone temperature control system of any of the preceding or subsequent example combinations, wherein the high temperature service fan is configured to operate at a temperature of up to about 1000° C.

EC 30. The cyclone temperature control system of any of the preceding or subsequent example combinations, wherein the cyclone threshold temperature is from about 330° C. to about 450° C.

EC 31. The cyclone temperature control system of any of the preceding or subsequent example combinations, wherein the cyclone threshold temperature is from about 340° C. to about 415° C.

EC 32. The cyclone temperature control system of any of the preceding or subsequent example combinations, wherein the cyclone threshold temperature is from about 350° C. to about 385° C.

EC 33. The cyclone temperature control system of any of the preceding or subsequent example combinations, wherein the cyclone threshold temperature is about 370° C.

The above-described aspects are merely possible examples of implementations, merely set forth for a clear understanding of the principles of the present disclosure. Many variations and modifications can be made to the above-described example(s) without departing substantially from the spirit and principles of the present disclosure. All such modifications and variations are included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed is:

1. A decoating system comprising:
a dust cyclone having a cyclone temperature and configured to:
receive an exhaust gas from a decoating kiln; and
filter particulate matter from the exhaust gas as dust;
an afterburner configured to produce a heated gas at a heated gas temperature, wherein the heated gas temperature is greater than the cyclone temperature; and
a cyclone temperature control system configured to selectively mix at least some of the heated gas from the afterburner with the exhaust gas from the decoating kiln such that the cyclone temperature is at least at a cyclone threshold temperature during operation.

2. The decoating system of claim 1, further comprising the decoating kiln, wherein the decoating kiln comprises:
a heating chamber;
a gas inlet for receiving an entry gas into the heating chamber;
a gas outlet for exhausting the exhaust gas from the heating chamber;
a scrap metal inlet for receiving scrap metal into the heating chamber; and
a scrap metal outlet for discharging the scrap metal from the heating chamber.

3. The decoating system of claim 2, wherein at least some of the entry gas comprises at least some of the heated gas from the afterburner.

4. The decoating system of claim 1, wherein the afterburner is configured to generate the heated gas by heating the exhaust gas from the dust cyclone.

5. The decoating system of claim 1, wherein the cyclone temperature control system is configured to selectively mix at least some of the heated gas with the exhaust gas before the exhaust gas enters the dust cyclone.

6. The decoating system of claim 1, wherein the cyclone threshold temperature corresponds to a temperature of the dust discharged from the dust cyclone at which the dust does not combust when exposed to ambient air.

7. The decoating system of claim 1, wherein the cyclone threshold temperature is from about 330° C. to about 550° C.

8. The decoating system of claim 1, wherein the cyclone temperature control system comprises:
a controller;
a gas mover configured to direct the heated gas to flow from the afterburner to mix with the exhaust gas; and
a control valve movable between a fully open position and a fully closed position.

9. The decoating system of claim 8, wherein the controller is configured to:
determine the cyclone temperature;
compare the cyclone temperature to the cyclone threshold temperature;
position the control valve in at least a partially open position and turn on the gas mover if the cyclone temperature is below the cyclone threshold temperature to direct the heated gas from the afterburner to mix with the exhaust gas; and
position the control valve in a closed position and turn off the gas mover if the cyclone temperature is at or above the cyclone threshold temperature, wherein in the closed position, the control valve prevents the flow of the heated gas from the afterburner to mix with the exhaust gas.

10. The decoating system of claim 9, wherein the gas mover is a high temperature service fan configured to operate at a temperature of at least about 800° C.

11. A method of controlling a temperature of a dust cyclone of a decoating system comprising:
determining a cyclone temperature of the dust cyclone of the decoating system;
comparing the cyclone temperature to a cyclone threshold temperature; and
opening a temperature control valve, turning on a gas mover, and directing at least some heated gas from an afterburner of the decoating system to mix with exhaust gas from a kiln of the decoating system to increase the temperature of the exhaust gas before it enters the dust cyclone if the cyclone temperature is less than the cyclone threshold temperature.

12. The method of claim 11 wherein opening the temperature control valve comprises positioning the temperature control valve in a partially open position such that less than a maximum amount of heated gas is directed to mix with the exhaust gas.

13. The method of claim 11, wherein opening the temperature control valve comprises positioning the temperature control valve in a fully open position such that a maximum amount of heated gas is directed to mix with the exhaust gas.

14. The method of claim 11, further comprising:
closing the temperature control valve and turning off the gas mover to prevent the heated gas from the afterburner from mixing with the exhaust gas from the kiln if the cyclone temperature is above the cyclone threshold temperature.

15. The method of claim 11, wherein the cyclone threshold temperature is from about 330° C. to about 450° C.

16. A cyclone temperature control system for a dust cyclone of a decoating system comprising:
a gas mover;
a control valve movable between a fully open position and a fully closed position; and
a controller configured to:
determine a cyclone temperature of the dust cyclone;
compare the cyclone temperature to a cyclone threshold temperature; and
position the control valve in at least a partially open position and turn on the gas mover if the cyclone temperature is below the cyclone threshold temperature to direct heated gas from an afterburner of the decoating system to mix with exhaust gas from a kiln of the decoating system.

17. The cyclone temperature control system of claim 16, wherein the controller is further configured to position the control valve in a closed position and turn off the gas mover if the cyclone temperature is at or above the cyclone threshold temperature, wherein in the closed position, the control valve prevents flow of the heated gas from the afterburner to mix with the exhaust gas.

18. The cyclone temperature control system of claim 16, wherein the controller is configured to position the control valve in the fully open position if the cyclone temperature is less than the cyclone threshold temperature such that a maximum amount of heated gas is directed to mix with the exhaust gas.

19. The cyclone temperature control system of claim 16, wherein the gas mover is a high temperature service fan configured to operate at a temperature of at least about 800° C.

20. The cyclone temperature control system of claim 16, wherein the cyclone threshold temperature is from about 330° C. to about 450° C.
